(19) United States
(12) Patent Application Publication
(10) Pub. No.: US 2013/0036743 A1
(43) Pub. Date: Feb. 14, 2013

(54) TURBOMACHINE COMBUSTOR ASSEMBLY

(71) Applicants: Abdul Rafey Khan, Greenville, SC (US); Krishna Kumar Venkataraman, Simpsonville, SC (US)

(72) Inventors: Abdul Rafey Khan, Greenville, SC (US); Krishna Kumar Venkataraman, Simpsonville, SC (US)

(73) Assignee: GENERAL ELECTRIC COMPANY, Schenectady, NY (US)

(21) Appl. No.: 13/204,777

(22) Filed: Aug. 8, 2011

(51) Int. Cl. F02C 9/26; F23D 11/38

(52) U.S. Cl. 60/772; 60/737; 431/181

(57) ABSTRACT

A combustor assembly includes a combustor body having a combustion chamber, and a nozzle support mounted to the combustor body. The nozzle support includes a central opening, and a plurality of openings extending about the central opening. A central flame tolerant nozzle assembly is positioned within the central opening, and a plurality of micro-mixer nozzle assemblies are mounted in respective ones of the plurality of openings about the central flame tolerant nozzle assembly. Each of the central flame tolerant nozzle assembly and the plurality of micro-mixer nozzle assemblies are configured and disposed to deliver an air-fuel mixture into the combustion chamber.

### BACKGROUND OF THE INVENTION

The subject matter disclosed herein relates to the art of turbomachines and, more particularly, to a combustor assembly for a turbomachine.

In general, gas turbomachines combust a fuel/air mixture that releases heat energy to form a high temperature gas stream. The high temperature gas stream is channeled to a turbine portion via a hot gas path. The turbine portion converts thermal energy from the high temperature gas stream to mechanical energy that rotates a turbine shaft. The turbine portion may be used in a variety of applications, such as for providing power to a pump or an electrical generator.

In a gas turbomachine, engine efficiency increases as combustion gas stream temperatures increase. Unfortunately, higher gas stream temperatures produce higher levels of nitrogen oxide (NOx), an emission that is subject to both federal and state regulation. Therefore, there exists a careful balancing act between operating gas turbines in an efficient range, while also ensuring that the output of NOx remains below mandated levels. One method of achieving low NOx levels is to ensure good mixing of fuel and air prior to combustion. Another method of achieving low NOx levels is to employ higher reactivity fuels that produce fewer emissions when combusted at lower flame temperatures.

### BRIEF DESCRIPTION OF THE INVENTION

According to one aspect of the invention, a combustor assembly includes a combustor body having a combustion chamber, and a nozzle support mounted to the combustor body. The nozzle support includes a central opening, and a plurality of openings extending about the central opening. A central flame tolerant nozzle assembly is positioned within the central opening, and a plurality of micro-mixer nozzle assemblies are mounted in respective ones of the plurality of openings about the central flame tolerant nozzle assembly. Each of the central flame tolerant nozzle assembly and the plurality of micro-mixer nozzle assemblies are configured and disposed to deliver an air-fuel mixture into the combustion chamber.

According to another aspect of the invention, turbomachine includes a compressor portion, a turbine portion operatively connected to the compressor portion, and a combustor assembly fluidly connected to the compressor portion and the turbine portion. The combustor assembly includes a combustor body having a combustion chamber, and a nozzle support mounted to the combustor body. The nozzle support includes a central opening, and a plurality of openings extending about the central opening. A central flame tolerant nozzle assembly is positioned within the central opening, and a plurality of micro-mixer nozzle assemblies are mounted in respective ones of the plurality of openings about the central flame tolerant nozzle assembly. Each of the central flame tolerant nozzle assembly and the plurality of micro-mixer nozzle assemblies are configured and disposed to deliver an air-fuel mixture into the combustion chamber.

According to yet another aspect of the invention, a method of combusting an air-fuel mixture in a turbomachine combustor assembly includes passing a first amount of air and a first amount of fuel to a central flame tolerant nozzle assembly, mixing the first amount of air and the first amount of fuel in the central flame tolerant nozzle assembly to form a first air-fuel mixture and discharging the first air-fuel mixture into a combustion chamber. The method also includes passing a second amount of air and a second amount of fuel to a plurality of micro-mixer assemblies arrayed about the central flame tolerant nozzle, mixing the second amount of air and the second amount of fuel within each of a plurality of tubes in the micro-mixer assemblies to form a plurality of second air-fuel mixtures, discharging the plurality of second air-fuel mixtures into the combustion chamber, and combusting the first air-fuel mixture and the plurality of second air-fuel mixtures in the combustion chamber.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial cross-sectional side view of a turbomachine including a combustor assembly in accordance with an exemplary embodiment;

FIG. 2 is a cross-sectional view of the combustor assembly of FIG. 1 including a nozzle assembly including a nozzle assembly in accordance with an exemplary embodiment;

FIG. 3 is cross-sectional view of the nozzle assembly of FIG. 2;

FIG. 4 is a plan view of the nozzle assembly of FIG. 2;

FIG. 5 is a cross-sectional perspective view of a central flame tolerant nozzle of the nozzle assembly of FIG. 3; and

FIG. 6 is a cross-sectional perspective view of one of a plurality of micro-mixer nozzles of the nozzle assembly of FIG. 3.

The detailed description explains embodiments of the invention, together with advantages and features, by way of example with reference to the drawings.

### DETAILED DESCRIPTION OF THE INVENTION

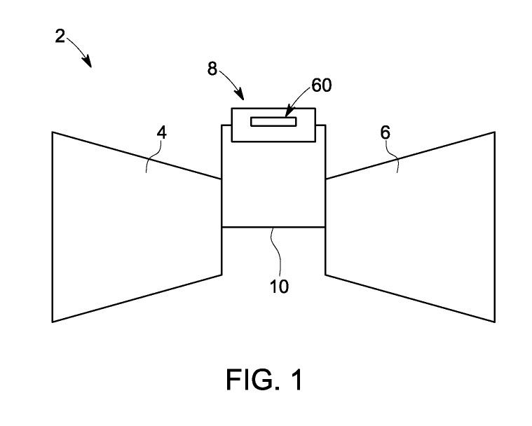

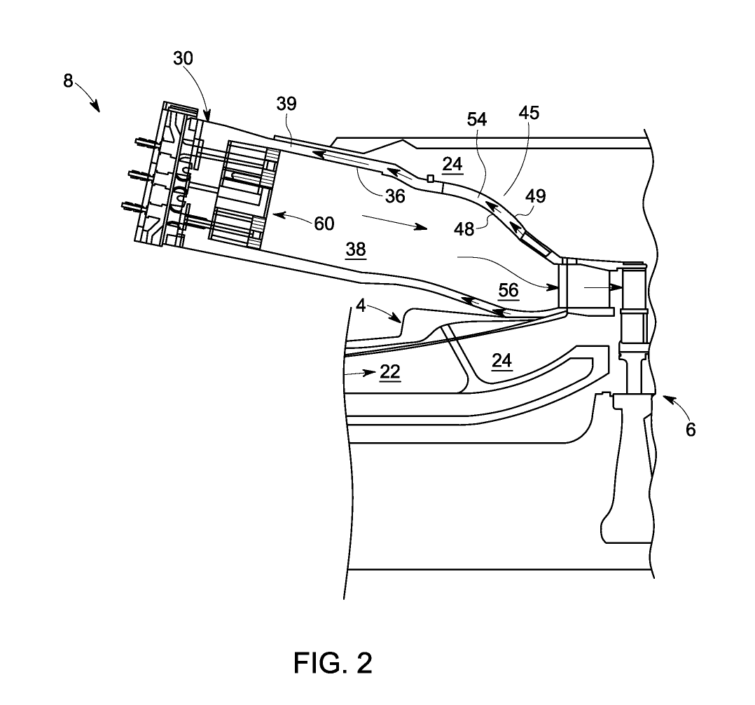

With initial reference to FIGS. 1 and 2, a turbomachine constructed in accordance with an exemplary embodiment is indicated generally at 2. Turbomachine 2 includes a compressor portion 4 connected to a turbine portion 6 through a combustor assembly 8. Compressor portion 4 is also connected to turbine portion 6 via a common compressor/turbine shaft 10. Compressor portion 4 includes a diffuser 22 and a compressor discharge plenum 24 that are coupled in flow communication with each other and combustor assembly 8. With this arrangement, compressed air is passed through diffuser 22 and compressor discharge plenum 24 into combustor assembly 8. The compressed air is mixed with fuel and combusted to form hot gases. The hot gases are channeled to turbine portion 6. Turbine portion 6 converts thermal energy from the hot gases into mechanical rotational energy.

Combustor assembly 8 includes a combustor body 30 and a combustor liner 36. As shown, combustor liner 36 is positioned radially inward from combustor body 30 so as to define a combustion chamber 38. Combustor liner 36 and combustor body 30 collectively define an annular combustion chamber cooling passage 39. A transition piece 45 connects combustor assembly 8 to turbine portion 6. Transition piece 45 channels combustion gases generated in combustion chamber 38 downstream towards a first stage (not separately labeled) of turbine portion 6. Transition piece 45 includes an inner wall 48 and an outer wall 49 that define an annular passage 54 defined between inner wall 48 and outer wall 49. Inner wall 48 defines a guide cavity 56 that extends between combustion chamber 38 and turbine portion 6. The above described structure has been provided for the sake of completeness, and to enable a better understanding of the exemplary embodiments which are directed to a nozzle assembly 60 arranged within combustor assembly 8.

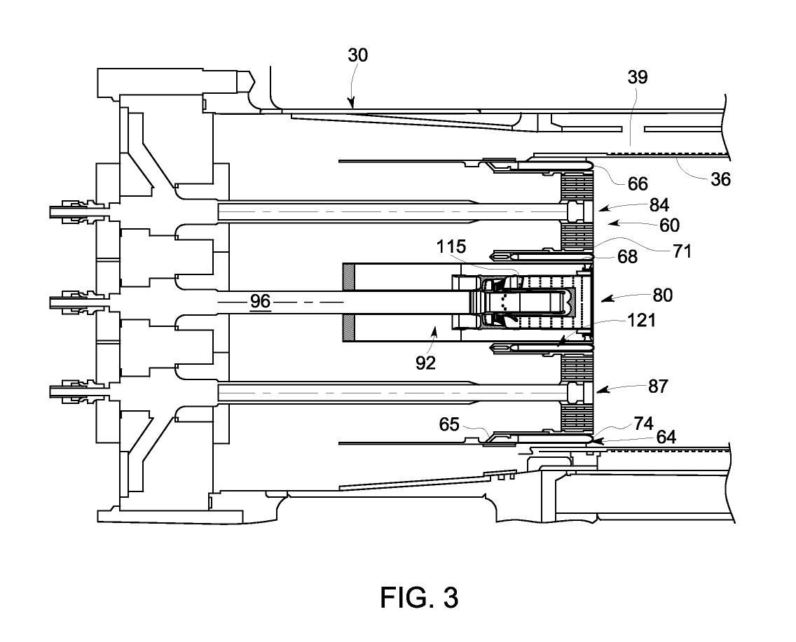

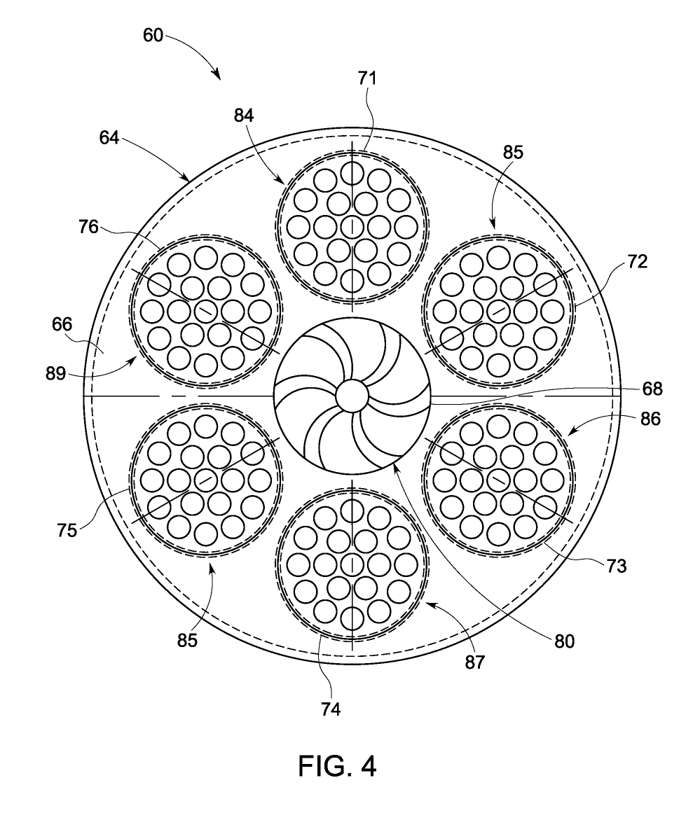

As best shown in FIGS. 3 and 4, nozzle assembly 60 includes nozzle support which, in the exemplary embodiment shown constitutes a cap member 64 that is positioned at an upstream end (not separately labeled) of combustion chamber 38. Of course it should be understood that other forms of nozzle supports can also be employed. Cap member 64 includes a first surface 65 and a second surface 66 exposed in combustion chamber 38. Cap member 64 includes a central opening 68 that extends between first and second surfaces 65 and 66. A plurality of openings 71-76 are arrayed about central opening 68 and also extend between first and second surfaces 65 and 66. A central, flame tolerant nozzle 80 is arranged within central opening 68, and a plurality of micro-mixer nozzle assemblies 84-89 are positioned within respective ones of openings 71-76. As will become more fully evident below, central, flame tolerant nozzle 80 is configured to withstand elevated temperatures and potential flame stabilization associated with burning higher reactivity fuels such as liquefied petroleum gas (LPG), fuels having higher hydrocarbons, hydrogen gas (H2), and syngas having increased flame holding properties.

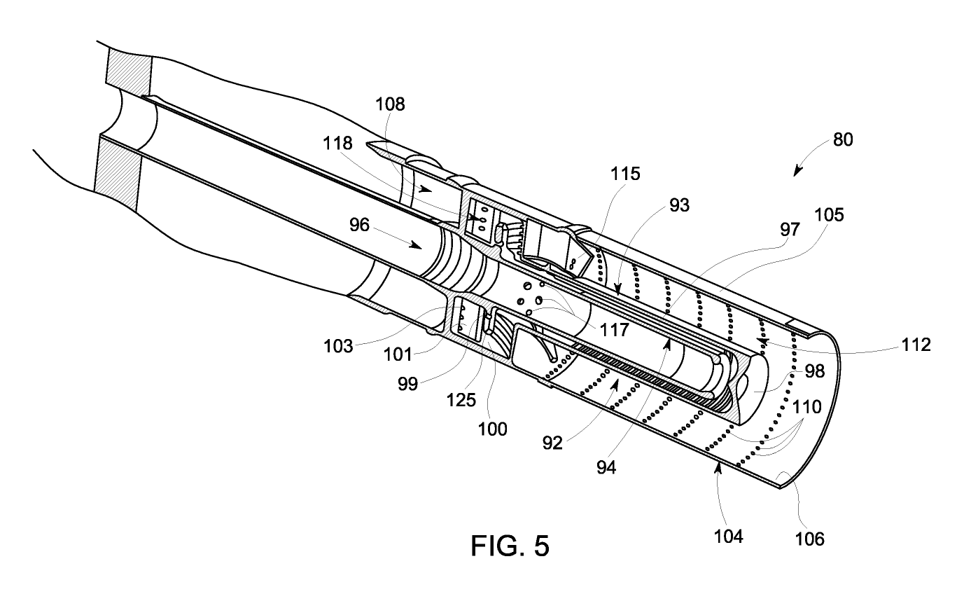

Referring to FIG. 5, central flame tolerant nozzle 80 includes a center body 92 having an outer body member 93 and an inner body member 94 that defines a fuel passage 96. Inner body member 94 is spaced from outer body member 93 so as to define an annular reverse flow fuel channel 97. Outer body member 93 includes an end wall 98 that deflects fuel passing through fuel passage 96 back into annular reverse flow fuel channel 97 toward a divider 99. Divider 99 forms a cooling chamber 100 and an outlet chamber 101 having a plurality of bypass openings 103. Central, flame tolerant nozzle 80 further includes a burner tube 104 that extends about center body 92. Burner tube 104 includes an outer surface 105 and an inner surface 106 and an air passage 108. Burner tube 104 also includes a plurality of rows of cooling passages 110 that extend between outer and inner surfaces 105 and 106. Burner tube 104 is spaced from center body 92 so as to define a fuel-air mixing passage 112.

Central, flame tolerant nozzle 80 is also shown to include a plurality of swirler vanes 115 that extend between center body 92 and inner surface 105 of burner tube 104. Swirler vanes 115 are fluidly connected to fuel passage 96 through a plurality of openings 117 formed in inner body member 94. Swirler vane 115 include fuel injection ports 118 that guide fuel from fuel passage 96 into fuel-air mixing passage 112 as will be discussed more fully below. Central, flame tolerant nozzle 80 also includes cooling passages 110 that facilitate the creation of a coolant film on burner tube 104 providing protection from hot combustion gases. The number, size, and angle of cooling passages 110, or the distance between the rows of cooling passages 110 may vary so as to achieve a desired wall temperature during flame holding events.

With this arrangement, fuel enters fuel passage 96 and flows toward end wall 98. The fuel then enters annular reverse flow channel 97 and flows upstream into a cooling chamber 100. The fuel flows around divider 99 and into outlet chamber 101 and into swirler vanes 115. In accordance with one aspect of the exemplary embodiment, divider 99 takes the form of a metal wall that restricts fuel flow direction into outlet chamber 101 thereby cooling internal surfaces of swirler vanes 115. Cooling chamber 100 and outlet chamber 101 may take on a variety of shapes including non-linear shapes such as, a zigzag coolant flow passage, a U-shaped coolant flow passage, a serpentine coolant flow passage, or a winding coolant flow passage. In addition to flow into swirler vanes 115, a portion of the fuel may also flow directly from the cooling chamber 100 to the outlet chamber 101 through by-pass openings 125 provided in the divider 99.

In accordance with an aspect of the exemplary embodiment, by-pass openings 125 may allow, for example, approximately 1-50%, 5-40%, or 10-20%, of the total fuel flow flowing across divider 99 to flow directly between cooling chamber 100 and outlet chamber 101. Utilization of the by-pass openings 103 may allow for adjustments to any fuel system pressure drops that may occur, adjustments for conductive heat transfer coefficients, or adjustments to fuel distribution to fuel injection ports 118. By-pass openings 125 may also improve fuel distribution into and through fuel injection ports 118. Additionally, by-pass openings 125 may reduce a pressure drop from cooling chamber 100 to the outlet chamber 101 thereby facilitating fuel passage through fuel injection ports 118. Furthermore, by-pass openings 103 may also allow for tailored flow through the fuel injection ports 118 to alter an amount of swirl imparted to the fuel flow prior to introduction into fuel-air mixing passage 112 via injection ports 118. In addition to discharging fuel, swirler vanes 115 impart a swirler to air flow passing through fuel-air mixing passage 112 to improve the fuel-air mixing. Accordingly, central, flame tolerant nozzle 80 takes the form of a pre-mixed swirling nozzle or swozzle. Moreover, the particular arrangement of bypass openings 103 provides fuel and cooling control that enables flame tolerant nozzle 80 to withstand flame holding and or flame ingestion events associated with burning higher reactivity fuels.

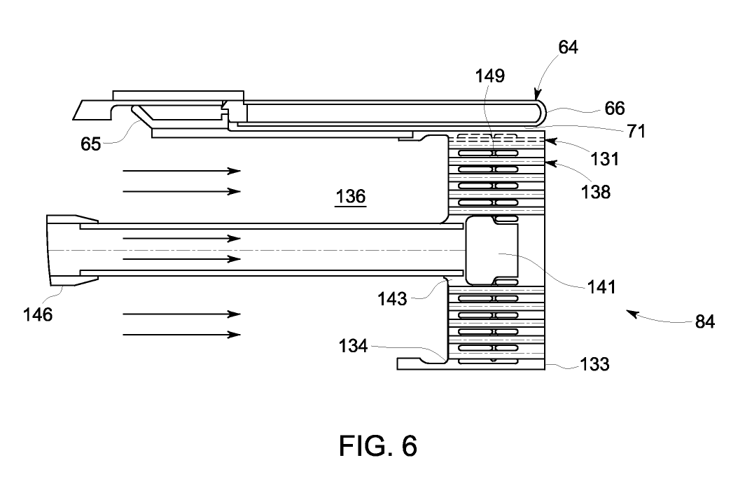

Reference will now be made to FIG. 6 in describing micro-mixer assembly 84 with an understanding that the remaining micro-mixer assemblies 85-89 may include corresponding structure. Micro-mixer assembly 84 includes a main body section 131 including a first end section 133 that extends to an opposing, second end section 134 that is exposed to an interior flow path 136. Micro-mixer assembly 84 also includes a plurality of mini-tubes, one of which is indicated at 138. Mini-tubes 138 fluidly interconnect interior flow path 136 and combustion chamber 38. In addition, bundled micro-mixer nozzle assembly 84 includes a central receiving port 141 that leads to an internal fuel plenum 143. At this point it should be understood that only one internal fuel plenum is shown and described, exemplary embodiments of the invention could include multiple fuel plenums. In any event, central receiving port 141 is fluidly connected to fuel inlet tube 146. In the exemplary embodiment shown, mini-tubes 138 are arrayed about a central receiving port 141. With this arrangement, fuel enters central receiving port 141 from fuel inlet tube 146. The fuel fills internal fuel plenum 143 and is distributed about each of the plurality of mini-tubes 138. In accordance with one aspect of the exemplary embodiment, each mini-tube 138 includes a fuel inlet such as indicated at 149.

The particular location of fuel inlet 149 establishes a desired air-fuel mixture. For example, arranging fuel inlet 149 adjacent to second surface 66 of cap member 64 provides a short mixing interval so as to establish lean, direct injection of fuel and air into combustion chamber 38. Arranging fuel inlet 149 centrally between first end section 133 and second end section 134 of main body section 131 establishes a partially pre-mixed injection of fuel and air into combustion chamber 38, and positioning fuel inlet 149 adjacent to first end section 133 establishes a more fully pre-mixed injection of fuel and air into combustion chamber 38. The length of tubes 138 and placement of fuel openings will be based on desired operating characteristics. Additionally, micro-mixer assembly 84 could have more than one fuel plenum with multiple fuel openings at different axial locations along the plurality of mini-tubes 138. With this arrangement, each micro-mixer assembly 84-89 may be constructed similarly or, provided in one of a plurality of configurations, e.g. lean direct injection, partially pre-mixed lean direct injection and fully pre-mixed lean direct injection, to control combustion within a particular combustor. The particular arrangement of mini-tubes 138 within micro-mixer nozzle assembly 84 facilitates the use of higher reactivity fuels. That is, the particular geometry of mini-tubes 138 inhibits injection of flame or flame holding within micro mixer nozzle assembly 84. In addition, the particular size, pattern and arrangement of mini-tubes may vary. Thus, higher reactivity fuels can be employed in combustor assembly 8.

The use of the central flame tolerant nozzle in combination with the micro mixer nozzle assemblies provides for flexibility of fuel choice. More specifically, the cooling features incorporated into the central flame tolerant nozzle, including for example, the fuel cooled center body, the center body tip, the swirler vanes, and the air cooled burner tube, enable the nozzle to withstand prolonged flame holding events. During such a flame holding event, the cooling features protect the nozzle from any hardware damage and allow time for detection and correction measures that blow the flame out of the pre-mixer and reestablish pre-mixed flame under normal mode operation. Thus, the combustor assembly may combust higher reactivity fuels such as full syngas as well as natural gas, high hydrogen gas and the like without suffering nozzle damage. The use of higher reactivity fuels leads to lower emissions, in particular NOx emissions that may increase an over all operational envelope of the turbomachine.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A combustor assembly comprising:
a combustor body including a combustion chamber;
a nozzle support mounted to the combustor, the nozzle support including a central opening, and a plurality of openings extending about the central opening;
a central flame tolerant nozzle assembly positioned within the central opening; and
a plurality of micro-mixer nozzle assemblies mounted in respective ones of the plurality of openings about the central flame tolerant nozzle assembly, each of the central flame tolerant nozzle assembly and the plurality of micro-mixer nozzle assemblies being configured and disposed to deliver an air-fuel mixture into the combustion chamber.

2. The combustor assembly according to claim 1, wherein the central flame tolerant nozzle assembly comprises a pre-mixed nozzle.

3. The combustor assembly according to claim 2, wherein the pre-mixed nozzle comprises a flame tolerant swozzle.

4. The combustor assembly according to claim 3, wherein the flame tolerant swozzle comprises a center body, a burner tube provided around the centerbody, the centerbody including a divider that forms a cooling chamber and an outlet chamber.

5. The combustor assembly according to claim 4, further comprising: at least one swirler vane extending between the centerbody and the burner tube, the at least one swirler vane being fluidly connected to the outlet chamber.

6. The combustor assembly according to claim 4, wherein divider includes at least one bypass opening that directly fluidly connects the cooling chamber and the outlet chamber.

7. The combustor assembly according to claim 4, wherein the centerbody includes an inner body member and an outer body member, a fluid passage defined by the inner body member, and an annular reverse flow channel defined between the outer body member and the inner body member.

8. The combustor assembly according to claim 1, wherein each of the plurality of micro-mixer nozzle assemblies includes a plurality of mini tubes, each of the plurality of mini tubes includes an air inlet and a fuel inlet configured and disposed to form an air-fuel mixture.

9. A turbomachine comprising:
a compressor portion;
a turbine portion operatively connected to the compressor portion;
a combustor assembly fluidly connected to the compressor portion and the turbine portion, the combustor assembly comprising:
a combustor body including a combustion chamber;
a nozzle support mounted to the combustor, the nozzle support including a central opening, and a plurality of openings extending about the central opening;
a central flame tolerant nozzle assembly positioned within the central opening; and
a plurality of micro-mixer nozzle assemblies mounted in respective ones of the plurality of openings about the central flame tolerant nozzle assembly, each of the central flame tolerant nozzle assembly and the plurality of micro-mixer nozzle assemblies being configured and disposed to deliver an air-fuel mixture into the combustion chamber.

10. The turbomachine according to claim 9, wherein the central flame tolerant nozzle assembly comprises a pre-mixed nozzle.

11. The turbomachine according to claim 10, wherein the pre-mixed nozzle comprises a flame tolerant swozzle.

12. The turbomachine according to claim 11, wherein the flame tolerant swozzle comprises a center body, a burner tube provided around the centerbody, the centerbody including a divider that forms an a cooling chamber and an outlet chamber.

13. The turbomachine according to claim 12, further comprising: at least one swirler vane extending between the centerbody and the burner tube, the at least one swirler vane being fluidly connected to the outlet chamber.

14. The turbomachine according to claim 12, wherein divider includes at least one bypass opening that directly fluidly connects the cooling chamber and the outlet chamber.

15. The turbomachine according to claim 12, wherein the centerbody includes an inner body member and an outer body member, a fluid passage defined by the inner body member, and an annular reverse flow channel defined between the outer body member and the inner body member.

16. The turbomachine according to claim 9, wherein each of the plurality of micro-mixer nozzle assemblies includes a plurality of mini tubes, each of the plurality of mini tubes includes an air inlet and a fuel inlet configured and disposed to form an air-fuel mixture.

17. A method of combusting an air-fuel mixture in a turbomachine combustor assembly, the method comprising:
passing a first amount of air and a first amount of fuel to a central flame tolerant nozzle assembly;
mixing the first amount of air and the first amount of fuel in the central flame tolerant nozzle assembly to form a first air-fuel mixture;
discharging the first air-fuel mixture into a combustion chamber;
passing a second amount of air and a second amount of fuel to a plurality of micro-mixer assemblies arrayed about the central flame tolerant nozzle;
mixing the second amount of air and the second amount of fuel within each of a plurality of tubes in the micro-mixer assemblies to form a plurality of second air-fuel mixtures;
discharging the plurality of second air-fuel mixtures into the combustion chamber; and
combusting the first air-fuel mixture and the plurality of second air-fuel mixtures in the combustion chamber.

18. The method of claim 17, further comprising: passing the first amount of air and the first amount of fuel across a swirler vane in the central flame tolerant nozzle to form the first air-fuel mixture.

19. The method of claim 17, passing a first cooling fluid into the central flame tolerant nozzle to cool portions of a center body and a burner tube extending about the center body.

20. The method of claim 19, further comprising: passing a second cooling fluid into the central flame tolerant nozzle to cool portions of a swirler vane.
